(19) United States
(12) Patent Application Publication
(10) Pub. No.: US 2026/0126341 A1
(43) Pub. Date: May 7, 2026

(54) OPTICAL COUPLING CALIBRATION METHOD, SYSTEM, AND RECORDING MEDIUM

(71) Applicant: JETEK TECHNOLOGY CORP., Hsinchu City (TW)

(72) Inventors: YU-HSIANG HUANG, Hsinchu City (TW); TIAN-YU SU, Hsinchu City (TW)

(73) Assignee: JETEK TECHNOLOGY CORP., Hsinchu City (TW)

(21) Appl. No.: 19/373,759

(22) Filed: Oct. 30, 2025

(30) Foreign Application Priority Data
Nov. 1, 2024 (TW) 113141860

(51) Int. Cl. G01M 11/02; G01M 11/08; G02B 6/26

(52) U.S. Cl. CPC G01M 11/0207; G01M 11/083; G02B 6/262

(57) ABSTRACT

An optical coupling calibration method for correcting a relative position between a fiber array and a device under test (DUT) through a nanoscale driving device includes setting a rotation center of a nanoscale driving device adjacent to a DUT; searching for an optimal coupling point; rotating along a first coordinate axis to collect first correction data; calculating a first rotation center deviation value from the first correction data; correcting a set value of the rotation center when the first rotation center deviation value exceeds a first threshold; rotating along a second coordinate axis to collect second correction data; calculating a second rotation center deviation value from the second correction data; correcting the set value when the second rotation center deviation value exceeds a second threshold; and positioning the rotation center onto the DUT based on the corrected set value using the first and the second rotation center deviation values.

### CROSS-REFERENCE TO RELATED APPLICATION

This non-provisional application claims priority under 35 U.S.C. § 119 (a) on Patent Application No(s). 113141860 filed in Taiwan, R.O.C. on Nov. 1, 2024, the entire contents of which are hereby incorporated by reference.

### BACKGROUND OF THE INVENTION

### 1. Field of the Invention

The present disclosure relates to an optical coupling calibration method, system, and recording medium, and in particular, to an optical coupling calibration method, system, and recording medium for correcting a relative position between a fiber array and a device under test (DUT).

### 2. Description of the Related Art

In cases such as optical coupling correction alignment of a silicon photonic element, for example, when optical coupling is performed between a fiber array and a device under test (DUT), since the alignment requires excessively high precision, nanoscale precision calibration is required when, for instance, the fiber array needs to be changed.

A conventional approach includes the use of a nanoscale driving device, such as a hexapod (which may implement six-axis motion at a nanoscale), a nanocube (which may implement a nanoscale three-axis translational actuation), a combination of fiber array fixtures, and the like. By setting a rotation center behind a fiber array and using a camera and a machine vision adjustment, a relative position between the fiber array and the DUT is corrected, and optical coupling alignment of an element is correspondingly performed.

### BRIEF SUMMARY OF THE INVENTION

However, as described above, a conventional optical alignment manner is to adjust and correct a position of an element through an observation method of an optical image such as an optical microscope (OM) with a fiber array as a rotation center. However, when angle correction is performed with the fiber array as the center, errors of ΔX, AY, and AZ are generated for a device under test (DUT). Therefore, a larger alignment range is required to have a chance to find a correct position, resulting in problems of a high error and long-time consumption.

In addition, the entire process of the conventional method involves many manual assistance and determination steps that require human participation, so that fully automatic correction cannot be implemented.

Therefore, how to provide a solution that is capable of simultaneously handling nanometer-scale optical coupling control, automatically controlling an operation of a nanoscale driving device, automatically performing optical coupling calibration, and automatically feeding back to perform deviation correction, so as to significantly improve efficiency of optical coupling correction of the element and reduce manual assistance steps that require human participation is of critical importance.

In view of the above, the present disclosure provides an optical coupling calibration method, system, and recording medium. Through setting a rotation center adjacent to a DUT before calibration, using a nanoscale driving device to adjust a relative position and angle between a fiber array and the DUT, and respectively rotating along a first coordinate axis and a second coordinate axis to collect a plurality of pieces of corresponding correction data, a deviation value between the rotation center and the DUT is obtained after regression calculation is performed on the corresponding correction data. Then, it is automatically determined whether to adjust and correct the rotation center to the DUT based on the deviation value, so that the rotation center is automatically corrected to the DUT, and the automatic calibration between the fiber array and the DUT is completed.

An embodiment of the present disclosure provides an optical coupling calibration method, which is configured for correcting a relative position between a fiber array and a device under test (DUT) through a nanoscale driving device. The optical coupling calibration method is suitable for being performed on a device. The optical coupling calibration method includes: setting a rotation center of a nanoscale driving device adjacent to a DUT; searching for an optimal coupling point; rotating along a first coordinate axis to collect a plurality of pieces of first correction data; calculating a first rotation center deviation value based on the plurality of pieces of first correction data; correcting a set value of the rotation center when the first rotation center deviation value is greater than a first threshold; rotating along a second coordinate axis to collect a plurality of pieces of second correction data, where the second coordinate axis is orthogonal to the first coordinate axis; calculating a second rotation center deviation value based on the plurality of pieces of second correction data; correcting the set value of the rotation center when the second rotation center deviation value is greater than a second threshold; and positioning the rotation center onto the DUT through correction based on the set value of the rotation center corrected by the first rotation center deviation value and the second rotation center deviation value. The nanoscale driving device is configured to control a position and an angle of the fiber array relative to the DUT.

According to the foregoing optical coupling calibration method, the plurality of pieces of first correction data and the plurality of pieces of second correction data are collected based on intensity of an optical signal received by the fiber array or the DUT.

According to the foregoing optical coupling calibration method, the searching for an optimal coupling point further includes: translating on a first plane, and collecting a plurality of pieces of first plane data; searching, based on the plurality of pieces of first plane data, for a maximum light intensity position having a maximum light receiving intensity; and using position information and angle information included in the maximum light intensity position as the optimal coupling point.

According to the foregoing optical coupling calibration method, the plurality of pieces of first correction data and the plurality of pieces of second correction data each includes a light receiving position, a light receiving angle, and a light receiving intensity corresponding to the light receiving position and the light receiving angle.

According to the foregoing optical coupling calibration method, the first rotation center deviation value includes a displacement deviation value of the second coordinate axis orthogonal to the first coordinate axis and a displacement deviation value of a third coordinate axis, and the displacement deviation value of the second coordinate axis and the displacement deviation value of the third coordinate axis are used for representing a deviation between the rotation center and the DUT on the second coordinate axis and a third coordinate axis.

According to the foregoing optical coupling calibration method, the second rotation center deviation value includes a displacement deviation value of the first coordinate axis orthogonal to the second coordinate axis, and the displacement deviation value of the first coordinate axis is used for representing a deviation between the rotation center and the DUT on the first coordinate axis.

According to the foregoing optical coupling calibration method, the first rotation center deviation value is a deviation value between the rotation center and the DUT on the second coordinate axis and a third coordinate axis obtained by performing linear regression analysis among a variation of an angle of rotation along the first coordinate axis, a second coordinate axis displacement, and a third coordinate axis displacement, and based on a slope and a coefficient of determination obtained through the linear regression analysis.

According to the foregoing optical coupling calibration method, the second rotation center deviation value is a deviation value between the rotation center and the DUT on the first coordinate axis obtained by performing linear regression analysis among a variation of an angle of rotation along the second coordinate axis, a first coordinate axis displacement, and a third coordinate axis displacement, and based on a slope and a coefficient of determination obtained through the linear regression analysis.

According to the foregoing optical coupling calibration method, the plurality of pieces of first correction data is collected at an interval of 0.5 degrees in an angle range of −2.5 degrees to 2.5 degrees along the first coordinate axis.

According to the foregoing optical coupling calibration method, the plurality of pieces of second correction data is collected at an interval of 0.1 degrees in an angle range of 0 degree to 1 degree along the second coordinate axis.

Another embodiment of the present disclosure provides an optical coupling calibration system, which is configured to correct a relative position between a fiber array and a DUT. The optical coupling calibration system includes: a nanoscale driving device, configured to drive to change a position and an angle of the fiber array relative to the DUT; a processor; and a storage apparatus, configured to store a plurality of program instructions, where the processor is adapted to perform the foregoing optical coupling calibration method after executing the plurality of program instructions.

Another embodiment of the present disclosure provides a non-transitory electronic device-readable record adapted for optical coupling calibration, storing a plurality of program instructions, so that an electronic device is adapted to perform the foregoing optical coupling calibration method after performing the plurality of program instructions.

Based on the optical coupling calibration method, system, and record of the present disclosure, the rotation center of the nanoscale driving device is set adjacent to the DUT before correction. The relative position and angle between the fiber array and the DUT is adjusted by using the nanoscale driving device. After preliminarily searching for the optimal coupling point, a plurality of pieces of corresponding first correction data and second correction data are respectively collected through rotating along the first coordinate axis and the second coordinate axis. A deviation value between the rotation center and the DUT on different coordinate axes is obtained after the regression calculation is respectively performed on the corresponding first correction data and second correction data. Then, it is automatically determined whether to adjust and correct the rotation center to the DUT by determining whether the deviation value is greater than a threshold, so that the rotation center is automatically corrected to the DUT. In this way, the effect that the optical coupling between the fiber array and the DUT can be automatically corrected without human participation and assistance is implemented. In addition, additional manners such as the machine vision, the optical image, and the microscope are not required to serve as a basis for determination and correction, so that correction time is significantly reduced, correction efficiency is improved, and the effect that the rotation center of the nanoscale driving device is set on the DUT after correction can be implemented.

### BRIEF DESCRIPTION OF THE DRAWINGS

FIG. 1 is a schematic flowchart of an optical coupling calibration method according to an embodiment of the present disclosure.

FIG. 2 is a schematic diagram of a nanoscale driving device used in an optical coupling calibration method according to an embodiment of the present disclosure.

FIG. 3 is a schematic block diagram of an architecture of an optical coupling calibration system according to an embodiment of the present disclosure.

### DETAILED DESCRIPTION OF THE INVENTION

To describe technical content and structural features of the present disclosure in detail, a description is provided in combination with implementations and accompanying drawings below. It should be noted that in the content of this specification, terms such as “first”, “second”, and “third” are used to distinguish between different elements, rather than to limit elements or indicate a specific order of the elements. In addition, in the content of this specification, the article “a/an” refers to one element or more than one element in a case that a specific quantity is not specifically indicated.

The present disclosure provides an optical coupling calibration method, system, and recording medium. Through setting a rotation center adjacent to a device under test (DUT) before calibration, using a nanoscale driving device to adjust a relative position and angle between a fiber array and the DUT, and respectively rotating along a first coordinate axis and a second coordinate axis to collect a plurality of pieces of corresponding correction data, a deviation value between the rotation center and the DUT is obtained after regression calculation is performed on the corresponding correction data. Then, it is automatically determined whether to adjust and correct the rotation center to the DUT based on the deviation value, so that the rotation center is automatically corrected to the DUT, and the automatic calibration between the fiber array and the DUT is completed.

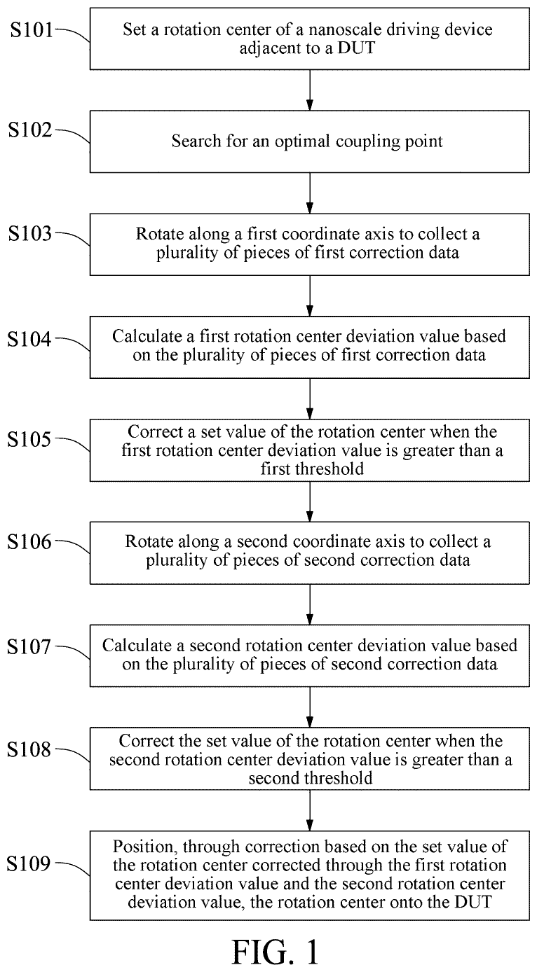

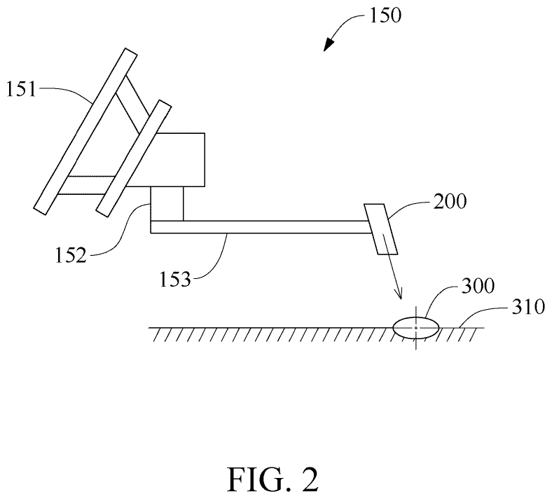

FIG. 1 is a flowchart of an optical coupling calibration method according to an embodiment of the present disclosure. FIG. 2 is a schematic diagram of a nanoscale driving device used in an optical coupling calibration method according to an embodiment of the present disclosure.

Referring to FIG. 1, the optical coupling calibration method provided in the present disclosure is suitable for being performed on an electronic device. The method may specifically be completed through step S101 to step S109 as shown in FIG. 1. In addition, the optical coupling calibration method is applicable to correcting a relative position between a fiber array and a DUT through a nanoscale driving device. The step number is merely an example and does not limit an operation sequence. The electronic device may be a desktop computer, a notebook, a tablet, a workstation, a server, a cloud server, a smartphone, and the like. The electronic device may also communicate with another electronic device through telecommunication transmission, to indirectly perform the optical coupling calibration method of the present invention through another electronic device. The electronic device may include an output module, which can provide visual display, audio output, or the like, such as a display, a touchscreen, a control panel, a projection, a stereoscopic projection, a speaker, and telephone voice. The electronic device may include an input module, such as a keyboard, a mouse, a joystick, a touchscreen, motion detection, and voice recognition.

Referring to FIG. 2, in an embodiment, the nanoscale driving device configured for adjusting a relative position and a relative angle between the fiber array and the DUT in the optical coupling calibration method may be as shown in FIG. 2. As shown in FIG. 2, in an embodiment, a nanoscale driving device 150 includes a nanometer hexapod driver 151, a nanometer three-axis translational actuator 152, and a control arm 153, and is configured to control a position and angle of a fiber array 200 in space, to adjust a position and an angle of the fiber array 200 relative to a DUT 300. The DUT 300 may be on a substrate 310 such as a wafer. Through the arrangement of the nanoscale driving device 150, the fiber array 200 can move and adjust an orientation in space on a nanoscale, so that a light such as a laser light can be precisely controlled and corrected to emit onto the DUT 300. Further, through a precise movement of an element in the nanoscale driving device 150 such as the nanometer hexapod driver 151 and the nanometer three-axis translational actuator 152, position and angle information of the fiber array 200 in space can be simultaneously recorded and/or outputted, so that the position and angle information can be provided to an electronic device and/or to be used in the optical coupling calibration method in an embodiment of the present disclosure. In an embodiment, the nanoscale driving device 150 and/or the electronic device may be integrated into an optical detector. The optical detector is configured to detect light outputted or received by the fiber array 200 to obtain light intensity information, and may also be configured to detect light received or outputted by the DUT 300 to obtain light intensity information. In this way, the position and angle information of the fiber array 200 in space and corresponding received or outputted light intensity information can be recorded and/or outputted.

Next, the process of the optical coupling calibration method in an embodiment of the present disclosure is described.

Referring to FIG. 1, in step S101, a rotation center of the nanoscale driving device is set adjacent to the DUT. Before the optical coupling calibration method is performed, since the rotation center of the nanoscale driving device is not located on the DUT, the rotation center of the nanoscale driving device is first set to a position adjacent to the DUT, so as to further perform subsequent correction processes. In addition, subsequently, a position and an angle of the fiber array relative to the DUT are controlled through the nanoscale driving device.

Referring to FIG. 1, in step S102, an optimal coupling point is searched for. During the initial correction, the optimal coupling point is searched through an initial wide-range light search, so as to facilitate the subsequent correction process. In an embodiment, the fiber array is displaced in a first plane, for example, XY translation is performed in an XY plane of the DUT, to collect a plurality of pieces of first plane data. Based on the data, a point having a maximum light receiving intensity and position and angle information thereof are searched. This point is used as the optimal coupling point, so as to facilitate the execution of another correction process, thereby improving correction efficiency.

Referring to FIG. 1, in step S103, rotation is performed along a first coordinate axis to collect a plurality of pieces of first correction data. In an embodiment, a plane where the DUT is located is set as the XY plane, and a direction orthogonal to the XY plane is set as a first coordinate axis. In other words, a Z direction is used as a direction of the first coordinate axis, a Y direction is used as a direction of a second coordinate axis, and an X direction is used as a direction of a third coordinate axis. In an embodiment, the fiber array is rotated along the first coordinate axis through the nanoscale driving device. In other words, the fiber array is rotated by a roll angle thereof along a Z-axis perpendicular to the XY plane of the DUT, so as to search for the optimal coupling point having the maximum light receiving intensity. Information thereof (including a position, an angle, and a light intensity value corresponding to the light receiving intensity) is recorded as a piece of first correction data. The same operations are repeated a plurality of times to collect a plurality of pieces of first correction data obtained by rotating along the first coordinate axis. In an embodiment, for example, rotating around the first coordinate axis (the Z-axis) can obtain a variation related to the second coordinate axis and the third coordinate axis. In other words, an XY variation and a variation of an angle can be obtained.

In an embodiment, an angle range for collecting the plurality of pieces of first correction data by rotating along the first coordinate axis may be set close to hardware limit value of the nanoscale driving device, for example, close to hardware limit value of the nanometer hexapod driver. It should be ensured that the optimal coupling point is received within the range. In an embodiment, a measurement angle range of the plurality of pieces of first correction data is in a range of −2.5 degrees to 2.5 degrees with an interval of 0.5 degrees. Therefore, a total of 11 measurement points exist, so as to balance advantages of sufficient data volume and time consumed by an appropriate correction process. For example, the angle range may slightly vary based on the correction of the fiber array. If the angle interval is excessively large, the collected information may be insufficient, while if the angle interval is excessively small, the total time consumed by the correction process may be excessively long. Therefore, an interval of 0.5 degrees is used to measure the angle in an angle range of −2.5 degrees to 2.5 degrees, and adjustment is made within one order of magnitude of the value to implement a balance between the information volume and the time consumed by the correction.

Referring to FIG. 1, in step S104, a first rotation center deviation value is calculated based on the plurality of pieces of first correction data. In an embodiment, a deviation value between the rotation center and the DUT is obtained by calculating the position and angle information in the plurality of pieces of first correction data. In an embodiment, similarly, an example in which the Z direction is used as the direction of the first coordinate axis, the Y direction is used as the direction of the second coordinate axis, and the X direction is used as the direction of the third coordinate axis is used. The same applies below herein. For example, linear regression analysis is respectively performed on the variation of the angle recorded in the plurality of pieces of first correction data and the variation of the displacement in the X and Y directions. A slope and an RSQ, namely, a coefficient of determination, are obtained through linear regression analysis. Deviation values X₀ and Y₀ between the rotation center and the DUT, namely, deviation values between the rotation center and the DUT on the second coordinate axis and the third coordinate axis, can be calculated through the following Equation (1). X₀ and Y₀ are the deviation values between the rotation center and the DUT in the X-axis direction and Y-axis direction, Δx and Δy are the variations of the displacement in the X-axis direction and Y-axis direction, and 40z is the variation of the angle around the Z-axis.

$${Y}_{0} = - \frac{Δ x}{Δ {θ}_{z}} , {X}_{0} = \frac{Δ y}{Δ {θ}_{z}} \qquad Equation ( 1 )$$

Referring to FIG. 1, in step S105, a set value of the rotation center is corrected when the first rotation center deviation value is greater than a first threshold. By comparing the first rotation center deviation value with the first threshold, it is determined whether the set value of the rotation center needs to be corrected. For example, when the first rotation center deviation value is greater than the first threshold, the set value of the rotation center is corrected based on the deviation value obtained as described above. If the first rotation center deviation value is not greater than the first threshold, the adjustment is not performed. In an embodiment, the first threshold is 0.7. In an embodiment, R² (RSQ) is used as the first threshold to evaluate a degree of fit between the obtained data and a mathematical model. When R²>0.7, the rotation center is corrected based on the foregoing calculation and analysis result. A smaller R² value indicates that the rotation center is closer to the DUT. In this way, the rotation center can be moved and corrected along the directions of the X and Y coordinate axes based on the foregoing calculation and analysis result during correction, so as to align with the DUT.

Referring to FIG. 1, in step S106, rotation is performed along the second coordinate axis to collect a plurality of pieces of second correction data. The second coordinate axis is orthogonal to the first coordinate axis. In an embodiment, the fiber array is rotated along the second coordinate axis (for example, using the Y-axis as an example) through the nanoscale driving device. In other words, the fiber array is rotated by a pitch angle thereof along the Y-axis, so as to search for the optimal coupling point having the maximum light receiving intensity. Information thereof (including a position, an angle, and a light intensity value corresponding to the received light intensity) is recorded as a piece of second correction data. The same operations are repeated a plurality of times to collect a plurality of pieces of second correction data obtained by rotating along the second coordinate axis. In an embodiment, for example, rotating around the second coordinate axis (the Y-axis) can obtain a variation related to the first coordinate axis and the third coordinate axis. In other words, an XZ variation and a variation of an angle can be obtained.

In an embodiment, a measurement angle range of the plurality of pieces of second correction data is in a range of 0 degree to 1 degree with an interval of 0.1 degrees. A total of 11 measurement points exist, so as to not only balance the advantages of sufficient data volume and the time consumed by an appropriate correction process as described above, but also ensure that a quantity of the plurality of pieces of second correction data matches a quantity of the plurality of pieces of first correction data, which facilitates comparison and analysis.

Referring to FIG. 1, in step S107, a second rotation center deviation value is calculated based on the plurality of pieces of second correction data. In an embodiment, a deviation value between the rotation center and the DUT is obtained by calculating the position and angle information in the plurality of pieces of second correction data. In an embodiment, for example, linear regression analysis is respectively performed on the variation of the angle recorded in the plurality of pieces of second correction data and the variation of a displacement in the Z and X directions. A slope and an RSQ are obtained through the linear regression analysis. A deviation value Z₀ between the rotation center and the DUT, namely, a deviation value between the rotation center and the DUT on the first coordinate axis, can be calculated through the following Equation (2). Z₀ is the deviation value between the rotation center and the DUT in the Z-axis direction, Δx is the variation of the displacement in the X-axis direction, and Δθ_{y} is the variation of the angle around the Y-axis.

$${Z}_{0} = \frac{Δ x}{Δ {θ}_{y}} \qquad Equation ( 2 )$$

Referring to FIG. 1, in step S108, the set value of the rotation center is corrected when the second rotation center deviation value is greater than a second threshold. In an embodiment, similar to the above description, by comparing the second rotation center deviation value with the second threshold, it is determined whether the set value of the rotation center needs to be corrected. For example, when the second rotation center deviation value is greater than the second threshold, the set value of the rotation center is corrected based on the deviation value obtained as described above. If the second rotation center deviation value is not greater than the second threshold, the adjustment is not performed. In an embodiment, the second threshold is also 0.7. In an embodiment, R² (RSQ) is also used as the second threshold to evaluate a degree of fit between the obtained data and a mathematical model. When R²>0.7, the rotation center is corrected based on the foregoing calculation and analysis result, and the second correction data corrects the direction of the first coordinate axis (the Z-axis). A smaller R² value indicates that the rotation center is closer to the DUT. In this way, the rotation center can be moved and corrected along the directions of the Z coordinate axis based on the foregoing calculation and analysis result during correction, so as to align with the DUT.

Referring to FIG. 1, in step S109, the rotation center is positioned, through correction based on the set value of the rotation center corrected through the first rotation center deviation value and the second rotation center deviation value, onto the DUT. Through the first rotation center deviation value obtained from the foregoing plurality of pieces of first correction data, the deviation of the rotation center relative to the DUT on the second coordinate axis and the third coordinate axis can be corrected. In addition, through the second rotation center deviation value obtained from the foregoing plurality of pieces of second correction data, the deviation of the rotation center relative to the DUT on the first coordinate axis can be corrected, so that the corrected rotation center is aligned on the DUT.

In this way, the rotation center of the nanoscale driving device can be precisely corrected and aligned on the DUT through the optical coupling calibration method of the present disclosure. Since the rotation center is precisely positioned on the DUT, any angular rotation in this case causes a light such as a laser light from the fiber array to be aimed at the DUT. Therefore, the optical coupling range can be significantly reduced and the time required for correction can be decreased.

In addition, by causing the plurality of pieces of first correction data and the plurality of pieces of second correction data to be collected based on strength of an optical signal received by the fiber array or the DUT, an effect that optical coupling between the fiber array and the DUT can be automatically corrected without human participation and assistance is implemented. Moreover, additional manners such as machine vision, an optical image, a microscope are not required to serve as a basis for determination and correction, so that correction time is significantly reduced and correction efficiency is improved. Further, through automated calculation, threshold determination, and deviation correction, the automated rotation center correction process can be implemented.

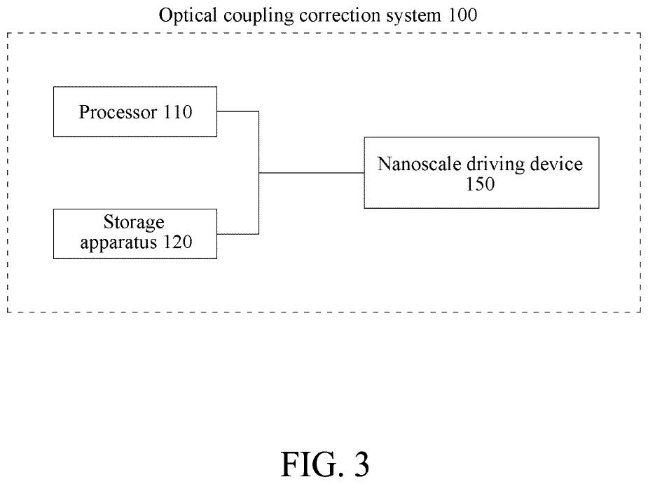

FIG. 3 is a block diagram of an architecture of an optical coupling calibration system according to an embodiment of the present disclosure. Another embodiment of the present disclosure is an optical coupling calibration system 100, which is suitable for performing the foregoing optical coupling calibration method. The optical coupling calibration system 100 includes a nanoscale driving device 150, a processor 110, and a storage apparatus 120. The processor 110 and the storage apparatus 120 may be included in the foregoing electronic device, but are not limited thereto. In an embodiment, the processor 110 and the storage apparatus 120 or an electronic device including the processor and the storage apparatus may further include an input module and an output module (not shown in the figure), to provide a visual and/or auditory user interface, such as a display, a touchscreen, a control panel, a projection, a stereoscopic projection, a speaker, telephone voice, a keyboard, a mouse, a joystick, a touchscreen, motion detection, and voice recognition. The nanoscale driving device 150 is configured to drive to change a position and an angle of the foregoing fiber array relative to the DUT. The storage apparatus 120 stores a plurality of program instructions. The processor 110 can perform steps S101-S109 shown in FIG. 1 and steps of another related embodiment after executing the program instructions. The electronic device may be a desktop computer, a notebook computer, a tablet computer, a workstation, a server, a cloud server, a smartphone, or the like. The storage apparatus 120 may be a hard disk, a memory, a server, a cloud server, or another type of memory, or a combination of a plurality of the foregoing storage data. The processor 110 may be, for example, a processing unit of a cloud server or a main processor of an electronic device. In an embodiment, the optical coupling calibration system 100 includes an optical detector. The optical detector is configured to detect light outputted or received by the fiber array to obtain light intensity information, and may also be configured to detect light received or outputted by the DUT to obtain light intensity information. In this way, the position and angle information of the fiber array in space and corresponding received or outputted light intensity information can be recorded and/or outputted.

Another embodiment of the present disclosure is a non-transitory electronic device-readable adapted for optical coupling calibration, storing the program instructions, so that an electronic device is adapted to perform the foregoing optical coupling calibration method after performing the plurality of program instructions.

Based on the optical coupling calibration method, system, and record of the present disclosure, the rotation center of the nanoscale driving device is set adjacent to the DUT before correction. The relative position and angle between the fiber array and the DUT is adjusted by using the nanoscale driving device. After preliminarily searching for the optimal coupling point calibration method within a wide range, a plurality of pieces of corresponding first correction data and second correction data are respectively collected through rotating along the first coordinate axis and the second coordinate axis. A deviation value between the rotation center and the DUT on different coordinate axes is obtained after the regression calculation is respectively performed on the corresponding first correction data and second correction data. Then, it is automatically determined whether to adjust and correct the rotation center on different coordinate axes to the DUT based on the deviation value by determining whether the deviation value is greater than a threshold, so that the rotation center is automatically corrected to the DUT. In this way, the effect that the optical coupling between the fiber array and the DUT can be automatically corrected without human participation and assistance is implemented. In addition, additional manners such as the machine vision, the optical image, and the microscope are not required to serve as a basis for determination and correction, so that correction time is significantly reduced, correction efficiency is improved, and the effect that the rotation center of the nanoscale driving device is set on the DUT after correction can also be implemented.

The present disclosure has been disclosed in the above with preferred embodiments. However, a person skilled in the art should understand that the embodiment is only used to illustrate the present disclosure, and should not be interpreted as a limitation on the scope of the present disclosure. It should be noted that all equivalent changes and substitutions to the embodiments should be considered to fall within the scope of the present disclosure. Further, the scope of the appended claims should be interpreted in the broadest manner to encompass all modifications, similar arrangements, processes, and the like.

While the present disclosure has been described by means of specific embodiments, numerous modifications and variations could be made thereto by those skilled in the art without departing from the scope and spirit of the present disclosure set forth in the claims.

What is claimed is:

1. An optical coupling calibration method, configured for correcting a relative position between a fiber array and a device under test (DUT) through a nanoscale driving device, wherein the optical coupling calibration method is suitable for being performed on an electronic device, and the optical coupling calibration method comprises:
setting a rotation center of the nanoscale driving device adjacent to the DUT;
searching for an optimal coupling point;
rotating along a first coordinate axis to collect a plurality of pieces of first correction data;
calculating a first rotation center deviation value based on the plurality of pieces of first correction data;
correcting a set value of the rotation center when the first rotation center deviation value is greater than a first threshold;
rotating along a second coordinate axis to collect a plurality of pieces of second correction data, wherein the second coordinate axis is orthogonal to the first coordinate axis;
calculating a second rotation center deviation value based on the plurality of pieces of second correction data;
correcting the set value of the rotation center when the second rotation center deviation value is greater than a second threshold; and
positioning the rotation center onto the DUT through correction based on the set value of the rotation center corrected by the first rotation center deviation value and the second rotation center deviation value, wherein
the nanoscale driving device is configured to control a position and an angle of the fiber array relative to the DUT.

2. The optical coupling calibration method according to claim 1, wherein the plurality of pieces of first correction data and the plurality of pieces of second correction data are collected based on strength of an optical signal received by the fiber array or the DUT.

3. The optical coupling calibration method according to claim 1, wherein the searching for an optimal coupling point further comprises:
translating on a first plane, and collecting a plurality of pieces of first plane data;
searching, based on the plurality of pieces of first plane data, for a maximum light intensity position having a maximum light receiving intensity; and
using position information and angle information comprised in the maximum light intensity position as the optimal coupling point.

4. The optical coupling calibration method according to claim 1, wherein the plurality of pieces of first correction data and the plurality of pieces of second correction data each comprises a light receiving position, a light receiving angle, and a light receiving intensity corresponding to the light receiving position and the light receiving angle.

5. The optical coupling calibration method according to claim 1, wherein the first rotation center deviation value comprises a displacement deviation value of the second coordinate axis orthogonal to the first coordinate axis and a displacement deviation value of a third coordinate axis, and the displacement deviation value of the second coordinate axis and the displacement deviation value of the third coordinate axis are used for representing a deviation between the rotation center and the DUT on the second coordinate axis and the third coordinate axis.

6. The optical coupling calibration method according to claim 1, wherein the second rotation center deviation value comprises a displacement deviation value of the first coordinate axis orthogonal to the second coordinate axis, and the displacement deviation value of the first coordinate axis is used for representing a deviation between the rotation center and the DUT on the first coordinate axis.

7. The optical coupling calibration method according to claim 1, wherein the first rotation center deviation value is a deviation value between the rotation center and the DUT on the second coordinate axis and a third coordinate axis obtained by performing linear regression analysis among a variation of an angle of rotation along the first coordinate axis, a second coordinate axis displacement, and a third coordinate axis displacement, and based on a slope and a coefficient of determination obtained through the linear regression analysis.

8. The optical coupling calibration method according to claim 1, wherein the second rotation center deviation value is a deviation value between the rotation center and the DUT on the first coordinate axis obtained by performing linear regression analysis among a variation of an angle of rotation along the second coordinate axis, a first coordinate axis displacement, and a third coordinate axis displacement, and based on a slope and a coefficient of determination obtained through the linear regression analysis.

9. The optical coupling calibration method according to claim 1, wherein the plurality of pieces of first correction data is collected at an interval of 0.5 degrees in an angle range of −2.5 degrees to 2.5 degrees along the first coordinate axis.

10. The optical coupling calibration method according to claim 1, wherein the plurality of pieces of second correction data is collected at an interval of 0.1 degrees in an angle range of 0 degree to 1 degree along the second coordinate axis.

11. An optical coupling calibration system, configured to correct a relative position between a fiber array and a DUT, wherein the optical coupling calibration system comprises:
a nanoscale driving device, configured to drive to change a position and an angle of the fiber array relative to the DUT;
a processor; and
a storage apparatus, configured to store a plurality of program instructions, wherein the processor is adapted to perform the optical coupling calibration method according to claim 1 after executing the plurality of program instructions.

12. A non-transitory electronic device-readable recording medium adapted for optical coupling calibration, storing a plurality of program instructions, so that an electronic device is adapted to perform the optical coupling calibration method according to claim 1 after performing the plurality of program instructions.
